(19) United States
(12) Patent Application Publication
(10) Pub. No.: US 2004/0225617 A1
(43) Pub. Date: Nov. 11, 2004

(54) Electronic commerce methods and apparatus

(76) Inventors: Carolyn Baser, Ft. Lauderdale, FL (US); Olivier Gorostis, Ft. (FR)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/869,330

(22) Filed: Jun. 16, 2004

Related U.S. Application Data
(63) Continuation of application No. 09/256,540, filed on Feb. 24, 1999.
(60) Provisional application No. 60/075,872, filed on Feb. 25, 1998.

(51) Int. Cl. G06F 17/60

(52) U.S. Cl. 705/78

(57) ABSTRACT

An object-oriented, distributed architecture provides a suite of applications supporting prepaid electronic commerce on internet, intranet or extranet, including roaming transactions and transaction shipping involving more complex configurations. A service request is received from a user, creating a transaction instance. Information relating to the user's PIN and remaining balance are retrieved to determine whether or not the transaction can take place given the user's remaining balance and, if the user's PIN is sufficiently funded, the transaction proceeds, rendering the requested service. An unrated service data record is returned, and the end user purchase price of the requested goods or services is calculated based upon the service data record. The PIN balance updated, and a transaction data record is generated as well. A typical roaming situation involves two transaction servers, called TxS devices. The first device, identified as a foreign TxS, is the place where the end user initiates the transaction. The second device, identified as the home TxS, holds the business information such as PIN funding for the prepaid account. The use of transaction shipment is not restricted to a typical roaming situation, but also applies to more complex roaming situations. An input device is employed for receiving a request for a service from an end user through a business application, forming part of an internet web page, for example, or through the use of a virtual Payment Portal™, which is manifest as an expandable widget/icon.

### RELATED APPLICATIONS

This application is a continuation of U.S. patent application Ser. No. 09/256,540 filed Feb. 24, 1999, which claims priority of U.S. Provisional Patent Application Serial No. 60/075,872 filed Feb 25, 1998.

### FIELD OF THE INVENTION

This invention relates generally to electronic commerce and, in particular, to an object-oriented, distributed architecture providing a suite of applications for implementing prepaid e-commerce in internet, intranet, and extranet environments.

### BACKGROUND OF THE INVENTION

Although a precise definition has yet to be adopted, electronic commerce or e-commerce, as it is called, generally means the process of conducting business transactions via networked computers, whether through direct connections or over the internet. Regardless of the definition, e-commerce includes various business-to-business transactions, including many on-line retail and financial processes.

The trend toward e-commerce began some 25 years ago, when larger corporations began transacting business with subsidiaries and suppliers over private networks. Recently, e-commerce has become more synonymous with business carried out over the internet, through webs sites, for example, to sell goods, services, and information to consumers.

Reliability, security and privacy remain concerns with regard to conducting business over the internet. Being packet-switched, internet messages typically move through various computers before arriving at a final destination, raising the potential for unauthorized interception. Existing architectures that depend upon internet protocols or e-mail communications therefore generally employ encryption schemes to enhance security. Other approaches address such problems through direct links to commercial banking networks, which often require users to open and maintain an account.

Generally speaking, most existing approaches to e-commerce rely on encryption involving the distribution of public or private encryption keys, which, in turn, requires measures to ensure that the keys are not lost or stolen.

Existing techniques also present problems in terms of network comparability. Telephony platforms based upon voice communications use switched networks, whereas the internet relies on packet routing. Whereas the switched network is based upon establishing a physical link, the internet routes packets from node-to-node to establish a communication. There is concern among internet users that the source and destination addresses are, themselves, not secure and subject to hacking activities.

Prior-art approaches to e-commerce generally use a hybrid configuration involving both switched and packet routing. A dial-up connection is used to gain access to the internet, for example. This hybrid approach generally does not yield the best of both worlds, however, since encryption keys must still be used with source and destination addresses subject to unauthorized tampering. The need still remains, therefore, for a pure e-commerce solution, preferably one which permits different kinds of transactions to occur through a consistent architecture.

### SUMMARY OF THE INVENTION

The subject invention resides in electronic commerce systems and processes, particularly with respect to the processing of prepaid transactions. The invention is specifically directed to an object-oriented, distributed architecture providing a suite of applications in support of electronic commerce through web service platforms on the internet or other points of sale, including intranet and extranet environments. The invention is not limited by the size of the transactions, and takes into account micropayments of the type which might otherwise be economically impractical through credit card purchases.

A method of performing a prepaid electronic-commerce transaction includes the steps of receiving a service request from a user, and creating a transaction instance. Information relating to the user's PIN and remaining balance are retrieved to determine whether or not the transaction can take place given the user's remaining balance and, if the user's PIN is sufficiently funded, the transaction proceeds, rendering the requested service. An unrated service data record is returned, and the price of the goods or services is calculated based upon the service data record. The PIN balance is updated, and a transaction data record is generated.

Five device components are preferably employed to complete a transaction, thus enabling any transaction server (TxS™) to be local or remote. A preferred system for carrying out electronic commerce in accordance with the invention includes the following components, the operations of which are coordinated by a transaction manager: an input device, an account device, a rating device, a service device, and an output device.

The input device is employed for receiving a request for a service from an end user through a business application, forming part of an internet web page, for example, or through the use of a virtual device called the Payment Portal™. The Payment Portal may be viewed as an expandable widget/icon which resides independently on any web browser/page. When selected the widget/icon is activated on the WEB page being viewed, allowing the end user to select the payment method, enter into a secure mode and then, if prepaid is selected, enter a debit account number (PIN) and a password in the fields provided for access to the prepaid account.

The account device performs account-management functions, including PIN verification operations. The rating device is used to calculate the purchase price associated with the service to be provided, as when purchasing time for multi-user games, downloading newspaper articles, etc. The service device actually provides the service. The output device for maintains transaction data record (TDR) queues accessible through a business application.

Through transaction shipment, an end user of the invention is not limited by geographic or national boundaries. Such roaming enables the end user to travel outside of a home location to an access point such as a web service platform on the internet or intranet/extranet/point-of-sale terminal in a country or region different from the one in which they normally receive service.

A typical roaming situation involves two TxS™ devices. The first device, identified as a foreign TxS, is the place where the end user initiates the transaction. The second device, identified as the home TxS, holds the business information for the prepaid account. It is the home device which is associated with a TxS that holds the PIN business information.

The foreign TxS receives the end user request and renders the service, once the PIN balance has been checked. The home TxS is requested by the foreign TxS to retrieve the PIN balance, perform the rating, and update the account. The nature of the distributed architecture enables roaming to be performed without any PIN data replication, thereby eliminating data inaccuracy and consistency issues.

The use of transaction shipment is not restricted to a typical roaming situation, but also applies to more complex roaming situations. For example, in a 3-TxS roaming situation, TxS#1 captures the request (ID) and services the requests (SD); TxS#2 holds the universal account device (AD) and the output device (OD); and TxS#3 holds the rating modules (RD).

### BRIEF DESCRIPTION OF THE DRAWINGS

FIG. 1 is a drawing of a four-layer architecture according to the invention;

FIG. 2 is a drawing of a business model according to the invention including five components coordinated by a transaction manager;

FIG. 3 illustrates different transaction steps associated with a prepaid electronic commerce example;

FIG. 4 illustrates the transaction of FIG. 3 in the form of a flow diagram;

FIG. 5 illustrates a typical roaming situation involves two transaction server devices;

Figure illustrates a transaction shipment according to the invention;

FIG. 7 depicts a roaming situation utilizing three transaction server devices;

FIG. 8 illustrates an example using a prepaid service from an HTML Web Page;

FIG. 9 is a diagram which shows how an end user may enter order information in through an HTML page;

FIG. 10 is a portion of an HTML page which contains a form whose action property invokes CorbaCgiServlet.doGet;

FIG. 11 provides a simplified code sample of CorbaCgiServlet;

FIG. 12 illustrates important transaction steps associated with a web service example;

FIG. 13 shows how, if more sophisticated features are required on the client side, the service HTML page can include references to embedded Java applets;

FIG. 14 is a UAD Entity Relationship Diagram based on a simple, two-entity model;

FIG. 15 represents a JAVA application and JAVA installation according to the invention;

FIG. 16 illustrates X/Open and OTS interfaces with respect to a credit/debit example according to the invention;

FIG. 17 is a UML diagram which depicts a transaction inheritance tree;

FIG. 18 is a UML diagram which depicts a transaction data record;

FIG. 19 is a UML diagram which depicts the transaction server and devices according to the invention;

FIG. 20 is a UML diagram which depicts requests and transaction creation; and

FIG. 21 is a UML diagram which depicts object interaction for the transaction shipments that occur in the typical roaming situation.

### DETAILED DESCRIPTION OF THE INVENTION

This invention resides in electronic commerce systems and processes, particularly with respect to the processing of prepaid transactions. The invention is specifically directed to an object-oriented, distributed architecture providing a suite of applications in support of true electronic commerce, as might be implemented through various wide- and local-area network service platforms or other points of sale (POS), including smart devices such as a PDA (Personal Digital Assistant), or virtual devices such as the Payment Portal™ described in further detail below. Although specific examples will make reference to the internet, one of skill in the art of distributed transaction processing will recognize that the invention is equally applicable to intranet and extranet environments. Nor is the invention limited by the size of the transactions, and takes into account micropayments of the type which might otherwise be economically impractical through credit card purchases.

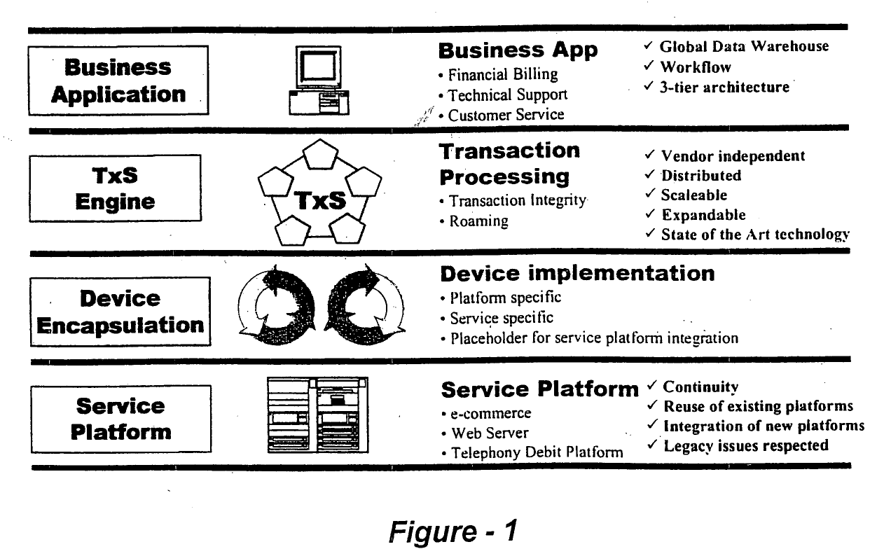

In a preferred embodiment the invention uses a consistent four-layer architecture as shown in FIG. 1. Broadly, the architecture integrates a business application suite to an enterprise node called the transaction server (TxS™), in such a way that transactions may be executed in a fully distributed mode. That is, a transaction initiated on one node may involve other nodes in order to be completed.

The top layer of the architecture is the business application level which pulls transaction records from the TxS and performs back-office operations. The TxS engine layer manages prepaid distributed transactions. The TxS engine is free of vendor-specific features, and has an open architecture, in that prepaid accounts can be initially set up by an existing debit platform vendor's software, then later used for other kinds of prepaid services through the TxS.

The device encapsulation layer enables a vendor platform or a server/device to interface with the TxS. The TxS interface defines a set of operations allowing distributed transactions. This layer is platform specific, in that interfaces must be written every time one integrates with a new type of service platform. However, since all WEB servers comply with standard interface specifications, this layer has already been implemented. The bottom layer is the service platform layer, which may function as a web server, point of sale, PDA, or other smart device.

The TxS engine defines interfaces for CORBA (Common Object Request Broker Architecture) services, and each service has a corresponding set of operations. Once a service has been made available, any of its operations can be requested over the network. Integrating a service platform with the TxS also implements its related interfaces. With respect to prepaid telephony, the TxS does not execute any debit functions or call processing. The TxS performs all debit processing steps as a pure e-commerce server solution for prepaid payments over internet/intranet/extranet.

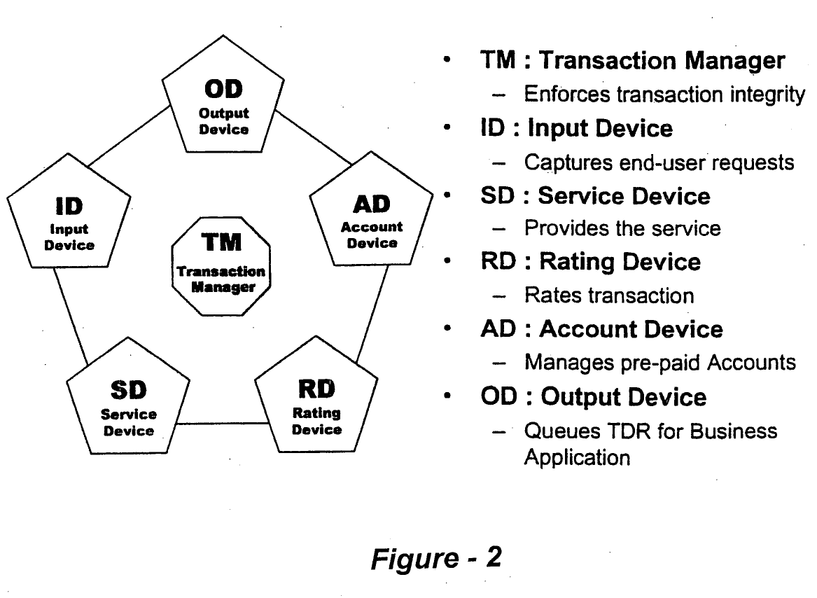

As shown in FIG. 2, the TxS business model consists of five components whose coordination is ensured by a transaction manager (TM). These components are:

1. The input device through which end user requests are received, as through a web page or virtual device forming part of a web-enabled service.

2. The account device which is responsible for carrying out lock, read and update PIN operations.

3. The rating device, which calculates purchase price of goods and services for the end user.

4. The service device, which renders the actual service, such as connecting multiple parties through a TCP/IP connection.

5. The output device, which maintains multiple transaction data record (TDR) queues available for the business application. The TxS engine defines interfaces for creating CORBA services, such that each service owns a set of operations. Once a service has been made available, any operation can be requested across the network.

Payment Portal™

In terms of the input device, the Payment Portal is one the techniques that the TxS may use for making network payments for products or services with a prepaid payment method using a debit account (or with a post-paid payment method associated with a credit card number). The Payment Portal may be viewed as an expandable widget/icon which resides independently on any web browser/page. When selected, the widget/icon will expand on the WEB page being viewed, allowing the end user to select the payment method, enter into a secure mode and then, if prepaid is selected, enter a debit account number (PIN) and a password in the fields provided.

The web page requesting payment will pass account device location and rate device location information to the Payment Portal. If a prepaid method is being used, the authorization of the account can be executed. If a purchase is authorized, the account decrementation can be accomplished at the account device specified. The final balance after the purchase will be shown in the Payment Portal.

A history of payments can be provided to the end user. In case of an estimate of the item's price, the rate device specified can be used to calculate the price without a purchase being made or without sufficient funds being available. The results are shown to the user in the Payment Portal's user interface.

Another use of the Payment Portal will be to top off (i.e., reload) any prepaid account balance at the specified account device with a credit card or through a home banking application where the end user can move some amount of money from a bank or credit card account to the prepaid account.

### Prepaid E-Commerce Transactions

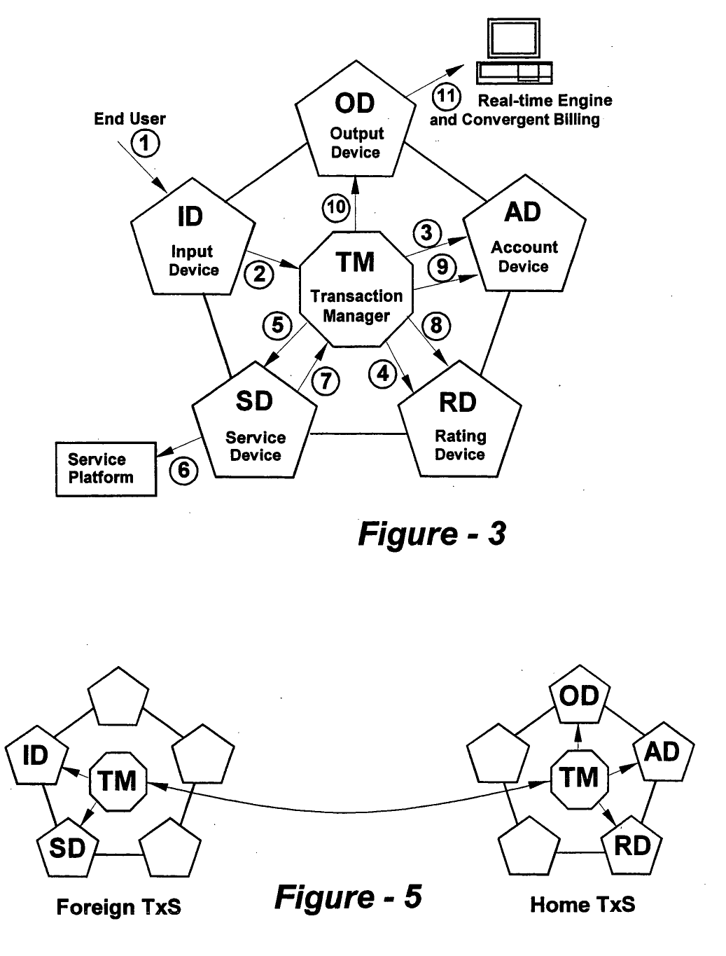

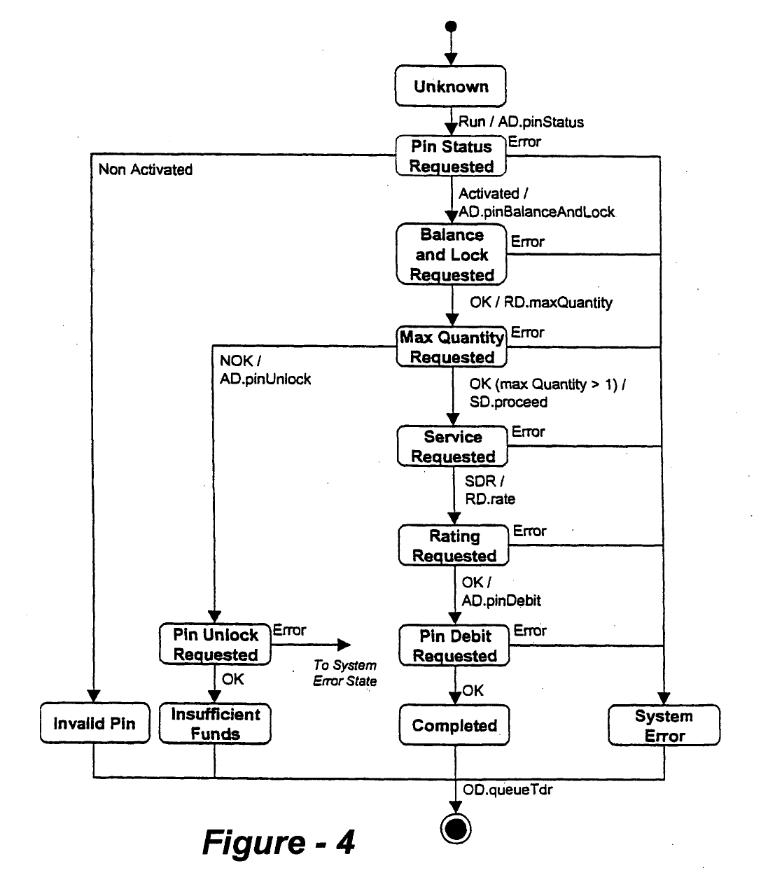

By way of a review, the transaction server or TxS is an e-commerce server that can be used for various types of prepaid services, including prepaid services on the Internet. With its account service, the TxS provides debit account management services, including account authorization, debiting and updating. FIGS. 3 and 4 illustrate the different transaction steps associated with a prepaid electronic commerce example. Referring first to FIG. 3, the primary steps are as follows:

1. Incoming request.

2. The transaction manager creates a transaction instance.

3. PIN authorization, lock and remaining balance retrieval.

4. The TM requests the RD to determine whether or not the transaction can take place, given the remaining balance.

5. If the PIN is sufficiently funded, the transaction manager requests the service device to proceed with the transaction.

6. Service platform renders the requested service (for example, placing an order).

7. The service device returns a raw (not rated) service data record (SDR).

8. The raw SDR is handed over to the rating device in order to calculate the cost of the transaction (i.e., the purchase price of the goods or services).

9. The transaction manager requests the account device to update the PIN balance and unlock the PIN.

10. A TDR is queued to the output device.

11. The business application retrieves the TDR.

FIG. 4 illustrates the transaction in the form of a flow diagram.

### Typical Roaming Situation (TRS)

As discussed above, five device components are preferably employed to complete a transaction, thereby enabling any TxS device to be local or remote. Roaming provides the ability for any end user to travel outside of their home location by a local access point (for example, a POS) in a country or region different from the one in which they normally receive service. An end user is not limited by geographic or national boundaries. Roaming creates a global system for end users.

FIGS. 5 illustrates a typical roaming situation involves two TxS devices. The first device, identified as a foreign TxS, is the place where the end user initiates the transaction. The second device, identified as the home TxS, holds the business information for the prepaid account. This platform is associated with a TxS that holds the PIN business information. The foreign TxS receives the end user request and renders the service once the PIN balance has been checked. The home TxS is requested by the foreign TxS to retrieve the PIN balance, to perform the rating and update the account. All the transaction steps are executed. The rating device and the account device operations are executed on a remote TxS. Note that the distributed architecture enables roaming to be performed without any PIN data replication, thereby eliminating data inaccuracy and consistency issues.

Two transaction managers are involved in the roaming situation just described. The transaction keeps running on one node as long as transaction steps can be executed locally. The transaction ships to another TxS node if a transaction step cannot be executed locally.

### Transaction Shipment for Typical Roaming Situation

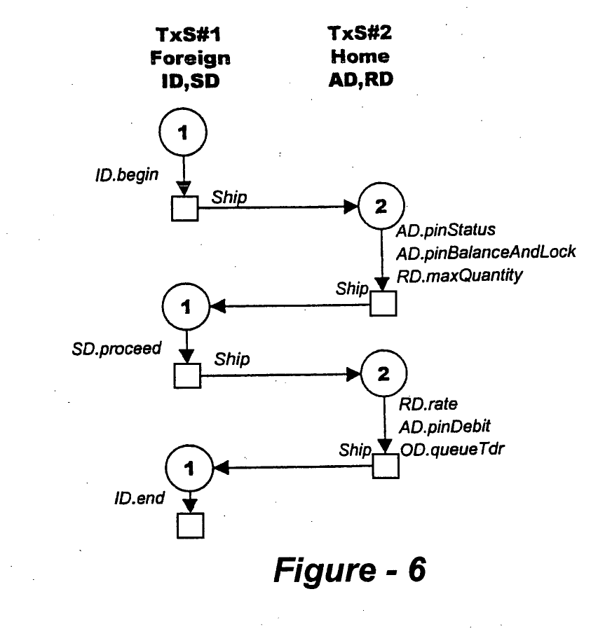

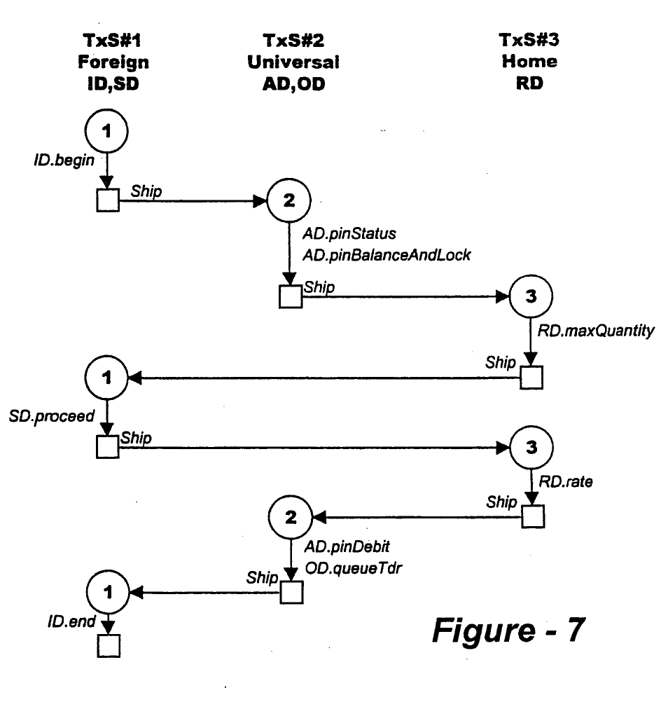

It is important that it should only take two messages back and forth to carry out a TRS transaction. This is achieved with transaction shipment, as shown in FIG. 6. In order to minimize the number of CORBA messages, a transaction keeps running on a TxS node as long as its local devices can service the request. The transaction ships to another TxS as soon as an operation (i.e., a transaction step) cannot be performed locally. Transaction shipment is of course not restricted to TRS transactions. It actually applies to all roaming situations. FIG. 7 depicts a 3-TxS roaming situation, wherein:

1. TxS#1 captures the request (ID) and services the requests (SD),

2. TxS#2 holds the universal account device (AD) and the output device (OD), and

3. TxS#3 holds the rating modules (RD).

### Web Service Platform Example

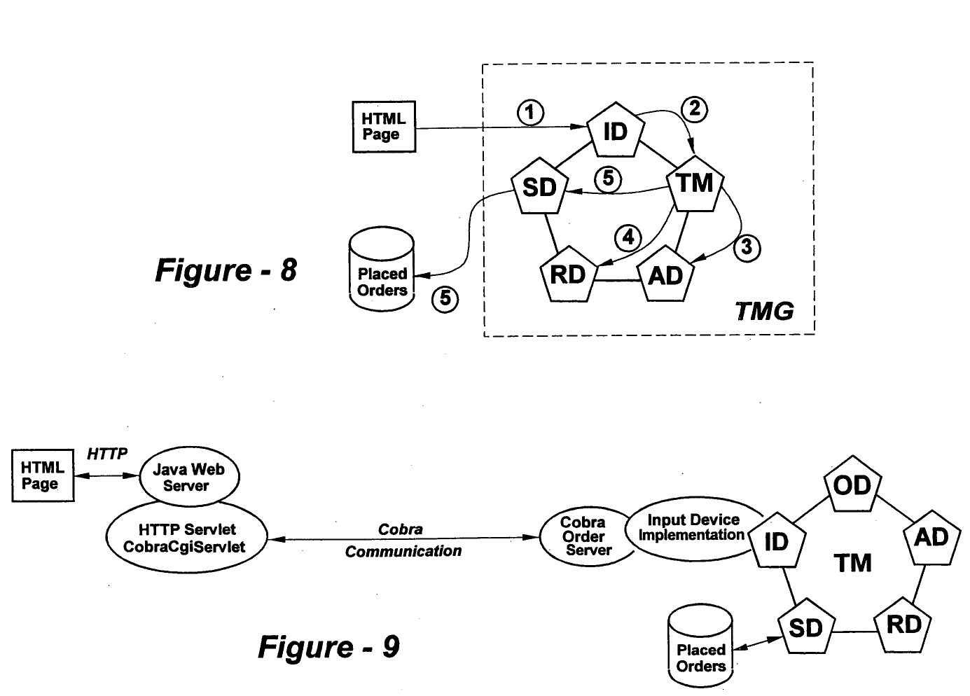

The following section describes an example using a prepaid service from an HTML Web Page, as depicted in FIG. 8. This application would be useful, for example, for placing any kind of order from a WEB browser. This embodiment implements an input device that allows the end user to enter a prepaid transaction request from an HTML page. The primary goal of this integration is to deliver the end user request to the TxS. Being a true e-commerce transaction, the account device need not be specific, allowing a basic universal account device to be used in this implementation. The account device may even be an account device previously used for another kind of service.

A specific rating device must be implemented, since parameters entered from the WEB page will be used to calculate the price of the goods or services purchased. For example, in a pizza ordering service, the end user chooses a pizza size and the toppings. These are quantifiable parameters used for calculating the pizza price. Discounts, club points, promotions and other sales methods can also be part of the rating model used. The service device takes care of placing the actual order. It might consist of writing a record in a database, or for example, sending a fax to the fulfillment center.

In this particular example, the input device may include a CORBA servlet that can be requested from any network node. The end user enters the order information in the HTML page, as shown in FIG. 9. When the end user submits its request, the HTTP Servlet DoGet method is invoked. The DoGet method locates and requests the CORBA Server.

The order entered on the Web page is eventually stored in a database by the service device. The orders placed in a database can be processed by an external application. The implementation comprises the following elements:

Web Server:

Any Web Server.

Input Device:

This component is an Input Device Implementation created from the MTG CORBA interface tmg.engine.InputDevice.

OrderServer:

CORBA service object associated with the Input Device. It is used by the Web Server to send an End User Request to the TxS. The Input Device creates the CORBA Server instance. The Order Server is a registered CORBA service whose name is “OrderServer” and that was created from the CORBA interface tools.web.CorbaCgilnterface.

CorbaCgiServlet:

Tools.web.CorbaCgiServlet extends javax.servlet.http.HtrtpServlet. Its DoGet method is called when the user submits their page to the HTTP Server. The CorbaCgiServlet is a CORBA client of the Order Server.

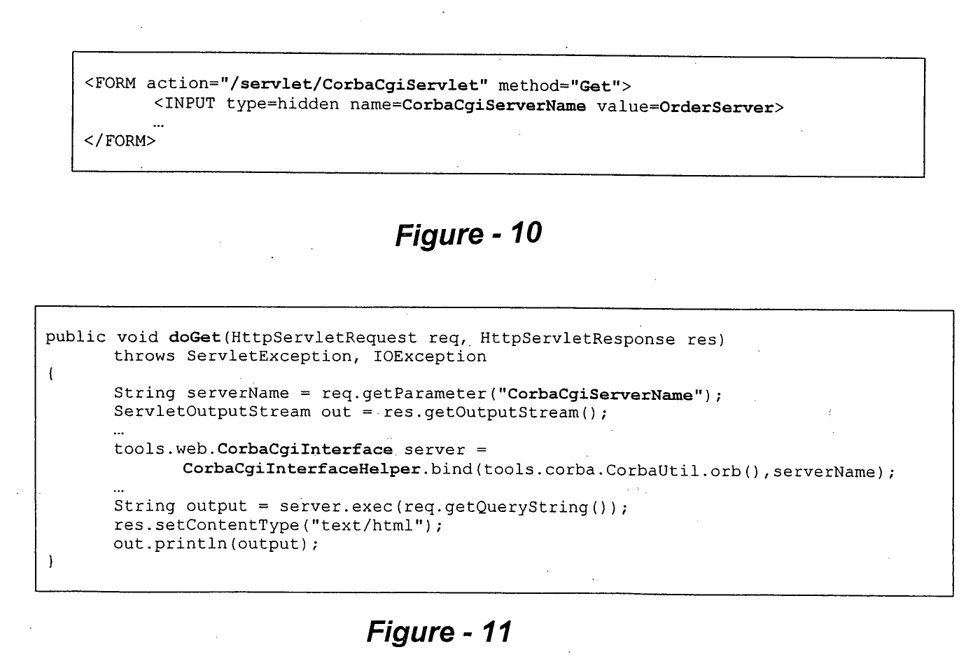

The HTML page contains a form whose “action” property invokes CorbaCgiServlet.doGet. It also has a property which gives the name of the OrderServer CORBA service, as shown in FIG. 10. The CorbaCgiServlet, shown in the paragraph of FIG. 11, provides a simplified code sample of CorbaCgiServlet. The doGet method retrieves the AdsServer name from the HTTP Request parameters and locates the corresponding CORBA service. The doGet method uses the servlet output stream to return a dynamically built HTML page.

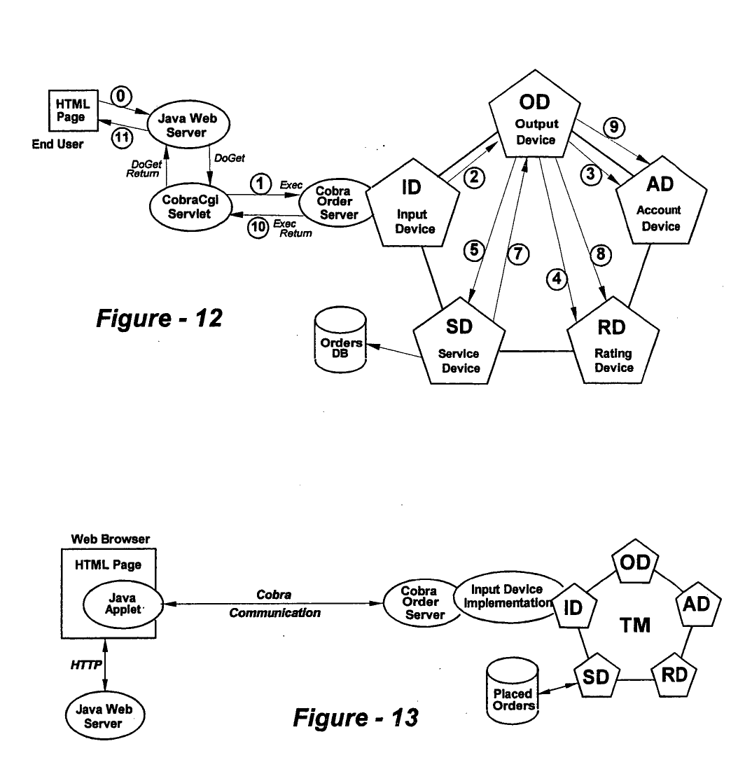

Transactions Steps (FIG. 12)

0 The end user submits the page to the Web Server. The HTTP request contains all the data entered by the end user (Prefix, PIN number, Order Description). The Do Get method of the Servlet is called.

1 The DoGet Method locates the CORBA Order Servlet associated with the input device and calls its “exec” method with the end user request as a parameter. The order servlet places the request in the input device queue. The “exec” method is synchronous, and waits until the end of the transaction.

2 The transaction manager reads the ID queue and creates a transaction instance.

3 PIN authorization, lock and remaining balance retrieval.

4 The TM requests the rating device to calculate the price of the goods or services purchased.

5 If the PIN is sufficiently funded, the transaction manager requests the service device to proceed with the transaction.

6 Create a new order in the orders database.

7 The order has been created and the service device returns a service data record.

8 Unlike telephony, the rating operation for ordering a physical item here is a void one, since the purchase price is known before the transaction has ended. However, for services that are metered, such as, interactive games and chat encounters, the rating will be done in real time as the transaction is ongoing.

9 The transaction manager requests the account device to update the PIN balance and unlock the PIN. A TDR is created and placed in one of the transaction manager queue.

10 The order server “exec” dynamically creates an HTML response page depending on the transaction outcome and then returns it to the CorbaCgiServlet.

11 The CorbaCgiServlet prints the dynamically created page into its output stream. The page is then displayed in the end user's Web browser.

Alternative Architecture (FIG. 13)

The Web Service architecture described above uses plain HTML pages that do not contain downloadable applets. A servlet is used for establishing communication with the TxS and this servlet is a client of the CORBA Order Server. If more sophisticated features are required on the Client side, the service HTML page can include references to embedded Java applets. In this architecture, shown in FIG. 13, the applet is the Client of the CORBA Order Server.

The Java client typically interacts with the server as follows:

1. Web Browser downloads HTML page that includes JAVA applets references.

2. Web Browser retrieves JAVA applet from HTTP Server.

3. The Java virtual machine embedded in Web Browser loads the applet and starts it.

4. The applet is now running on the client and invokes the Order Server using CORBA.

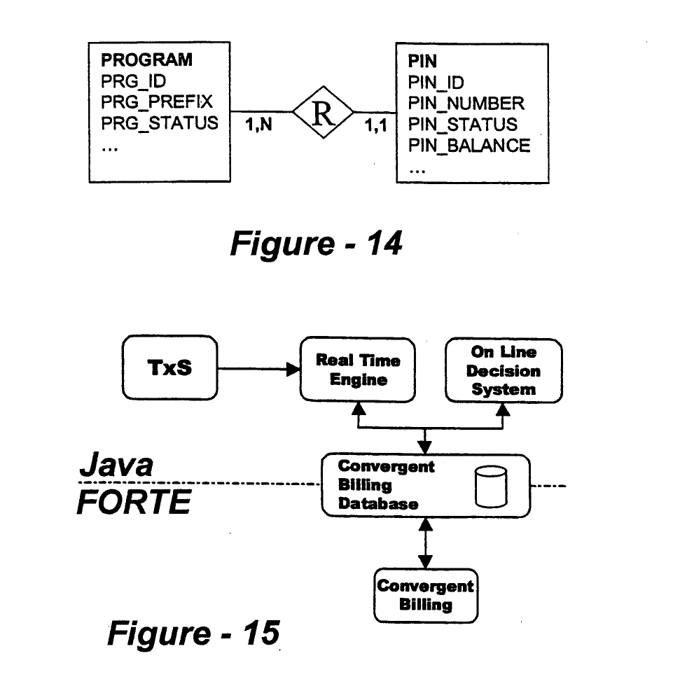

Universal Account Device (FIG. 14)

The Universal Account Device, or UAD, is a PIN database that can be used for any prepaid service. The UAD implementation preferably uses Oracle 8.0. The UAD Entity Relationship Diagram is based on a very simple, two-entity model, as shown in FIG. 14. Simultaneous prepaid transactions using the same account is possible as long as business rules are well defined. The introduction of such business rules allowing simultaneous use can be described as Soft Locking versus Hard Locking that locks out anyone else when the prepaid account is being used.

Output Device

The output device is the counterpart to the input device, in the sense that it is in charge of managing the TDR after transactions have taken place; namely, queuing, pull interface for the business application, and so forth. The output device also supports multiple transactions queues and multiple client TDR retrieval.

JAVA Applications

As shown in FIG. 15, JAVA applications preferably use the J'Express 3.0 Full Java installation product, which includes:

The TransactionServer

The OnLineDecisionSystem

The RealTimeEngine

Fault Tolerance

Fault tolerance is required for the TxS Trader and for each TxS node. Visibroker provides fault tolerance by starting instances on multiple hosts. If a client is connected to an object implementation, and the connection is lost, the Visibroker Smart Agent detects the loss and automatically reconnects the client to another instance. However, Trader and TxS are object implementations that maintain states, which means that a lost connection will not be transparent to the client. Visibroker provides events' handler mechanisms to bring the state of a replica implementation up to date.

Load Balancing

With Load Balancing, requests can be automatically routed to different servers so as to dynamically balancing the request load. Visibroker uses Smart Stubs to provide load balancing (the smart stub invokes the least loaded of several equivalent remote objects).

Administration GUI

First stage is a simple administration GUI that enables an administrator to change device configurations without bringing down the TxS. This mainly includes add/remove programs/prefixes to and from a TxS. At the present time, TxS devices are preferably loaded from a file at start up time and cannot be changed unless a TxS shutdown is performed. Second stage will include a slicker interface intended for commercial use (i.e., device graphical representations, additional information supervision information).

SNMP Agent

The SNMP agent (e.g., Java Advent) provides an interface to a manager application so that the TxS can be supervised and monitored. This interface preferably contains:

A set of variables that facilitates monitoring (the manager can invoke set and get operations for these variables),

A set of Trap messages (these messages can be sent to the manager upon detection of an abnormal condition or for example when a variable goes above or beyond a predefined threshold).

Counter Agent

The motivation behind the counter agent is a licensing policy based on transaction volume and number of occurrences. For example, a license fee might be paid for the first 10 million transactions, with upgrade fees being required if a predefined threshold is exceeded. A counter agent will manage transaction counting. If invoked, the counter agent will have the ability to shut down the TxS upon reaching a predetermined threshold limit.

OTS Interfaces and X/OPEN Mapping

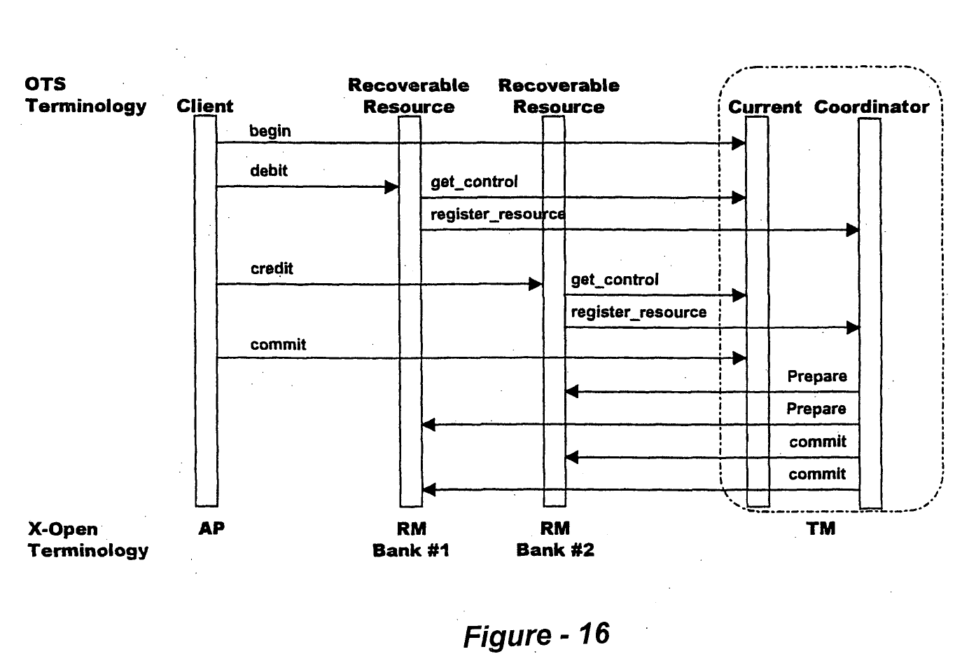

FIG. 16 illustrates X/Open and OTS Interfaces with respect to a credit/debit example. The main OTS interfaces are:

1. Current is a CORBA pseudo object that makes it easy for clients to use OTS. Clients invoke begin and commit operations.

2. Coordinator is implemented by the transaction service. Recoverable objects use it to coordinate their participation in the transaction. Phase#1 occurs when the coordinator asks each participant to vote (prepare operation). If all participants agree, coordinator performs phase#2 (asks all participants to commit).

3. Resource: recoverable server object participating in a two-phase commit (prepare operation is the vote).

Transaction Management and Transaction Shipping

The objective of transaction shipping is to minimize the number of CORBA messages in roaming situations. In a roaming situation, a transaction ships or travels from one TxS to another. Therefore, it globally consists of consecutive run sequences executed on different TxS devices. The global transaction can also be seen as an execution path: The same TxS may of course appear several times in an execution path but two adjacent TxS are necessarily different.

A run sequence consists of several operations. The outcome of one operation determines what the next operation is. The transaction ships if the next operation cannot be executed locally.

A TxS knows what its own capabilities are (they are loaded from the TxS devices file at start time or updated via the administration GUI application). A transaction thread can determine at any time from end user request properties if a local device can perform the next operation or if shipment needs to occur.

Each TxS caches the other TxS it establishes communication with. TxS-to-TxS communication mainly occurs for shipping transactions. When a TxS needs to ship a transaction to another TxS, it first looks it up in its TxS cache. The alternative is:

1. The looked-up TxS is not found in the cache. It asks the trader the name of the TxS that can perform the operation, gets a reference to that TxS (CORBA bind), caches the reference and ships the transaction, and

2. The looked-up TxS is found in the cache. The TxS just uses the cached remote reference (with no preparatory ping!) and tries to ship the transaction. If the first shipping attempt fails, that means the cached reference is obsolete. The obsolete reference is removed from the cache and the TxS does as if the reference had not been found in the cache in the first place.

### Design Diagrams

This section of the description provides further details of the technical design utilizing the UML notation. Class diagrams will first be presented, followed by a TRS interaction diagram for the shipments which occur in a typical roaming situation.

### Class Diagrams

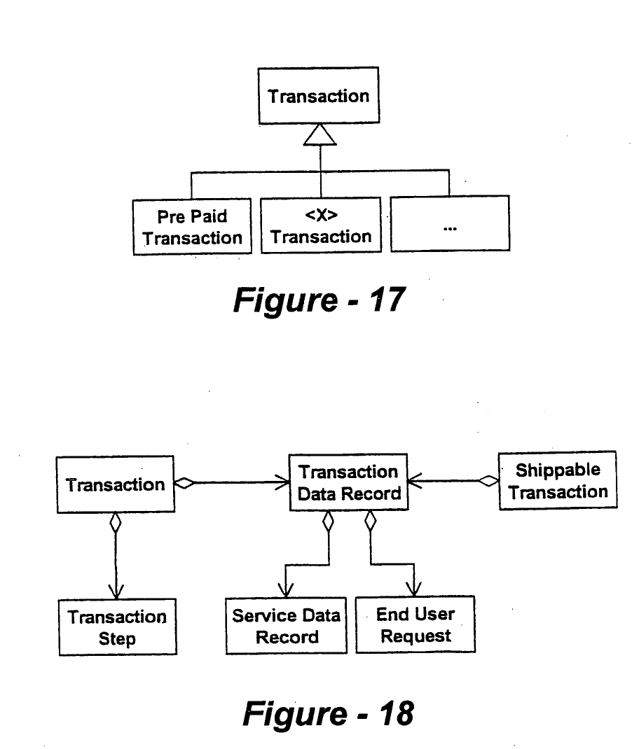

Transaction Inheritance Tree (FIG. 17)

The TxS is capable of dealing with different business models. Each transaction subclass matches a business model (e.g.: prepaid, postpaid, and so forth), containing all the behaviors required for implementing that model. Each transaction is a sequence of operations whose execution order is coded in each subclass. Upon termination of an operation (or transaction step), the subclass analyzes its outcome and decides what the next one will be and if a shipment needs to occur. The transaction super-class holds necessary information for general transaction management (transaction state, reference to the local TxS, next operation to be executed, etc.).

Transaction Data Record (FIG. 18)

The TDR aggregates all the information that pertains to a transaction. It consists of three data groups:

1. General: Identification, State, Begin and End Time Dates

2. End User Request: Origin, Type (the kind of transaction that is requested: prepaid, postpaid, etc. . . . PIN, Prefix; and

3. Service Data Request: Record return by the Service Device proceed call. Price, quantity, Additional properties specific to the service device.

As the transaction progresses and possibly travels around, the TDR builds up. It is completed when the last step of the transaction has been executed. The shippable transaction class is only used for shipping. Its purpose is to make shipments as small as possible. One needs to be able to create a shippable transaction from a transaction (at shipment time) and vice versa (upon receipt of a shipped transaction). The shippable transaction only consists of the next step to be executed and the TDR.

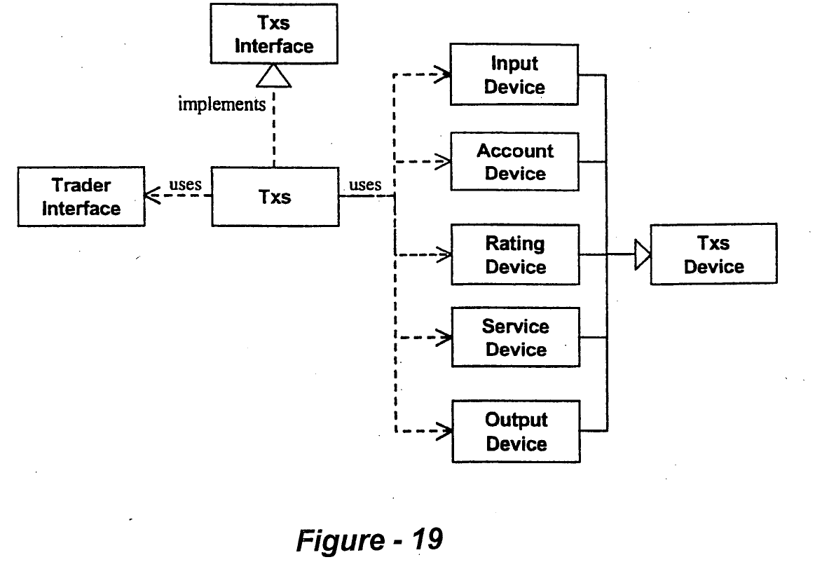

TxS and Devices (FIG. 19)

The TxS class is the TxS engine. It is associated with device implementations through the five interfaces: input device, account device, rating device, service device and output device. The role of the TxS devices is described elsewhere herein. The TxS engine manipulates its devices only through its interfaces and does not know about device implementations. Device implementation classes are chosen at start-up time. When a TxS starts up, it advertises its responsibilities to the TxS Trader. The TxS uses the TxS Trader to locate other TxSs across the network.

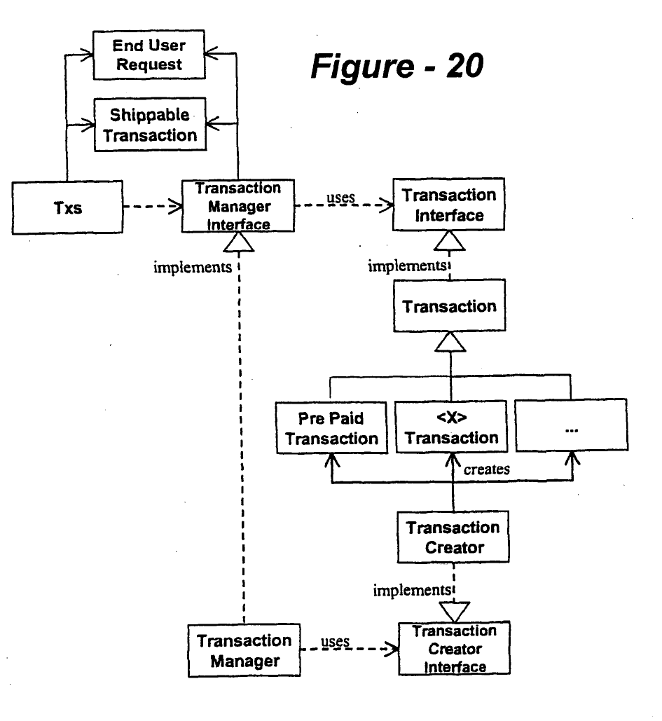

Requests and Transaction Creation (FIG. 20)

When an end user request or a shipped transaction comes in, the TxS just hands it over to the transaction manager that is in charge of creating the corresponding transaction subclass and starting a transaction thread.

The TxS uses the transaction manager through an interface.

The transaction manager uses the transaction creator through an interface.

The transaction creator can carry out three different operations:

1. Turn an end user request into a transaction interface reference (a new request has come in).

2. Turn a shippable transaction into a transaction interface reference (a shipped transaction has come in).

3. Turn a transaction interface reference into a shippable transaction (a shipment needs to occur).

The transaction manager always manipulates transactions through the transaction interface and does not know anything about transaction subclasses. The only class that needs to know about transaction subclasses is the transaction creator.

TRS Interaction

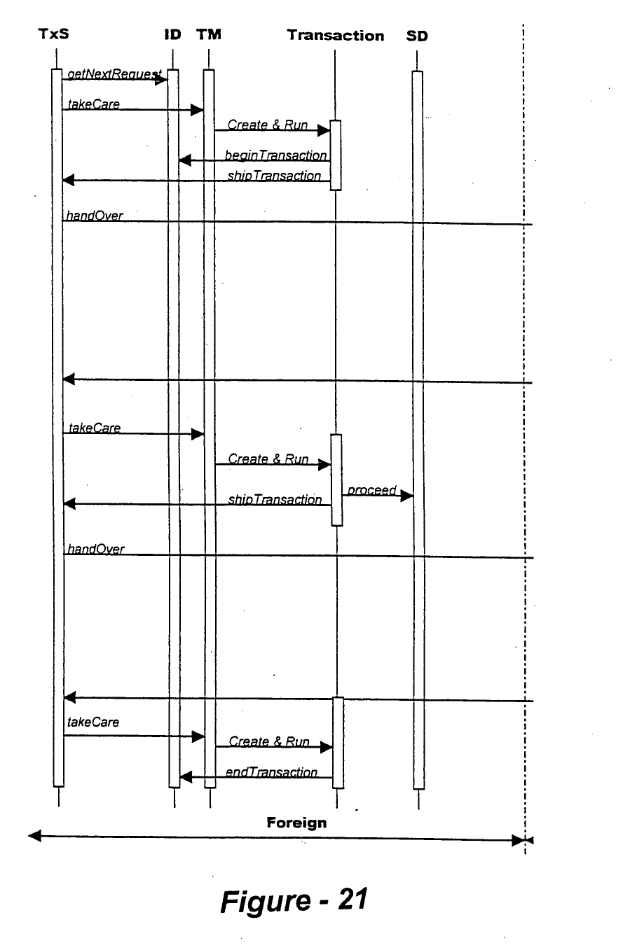

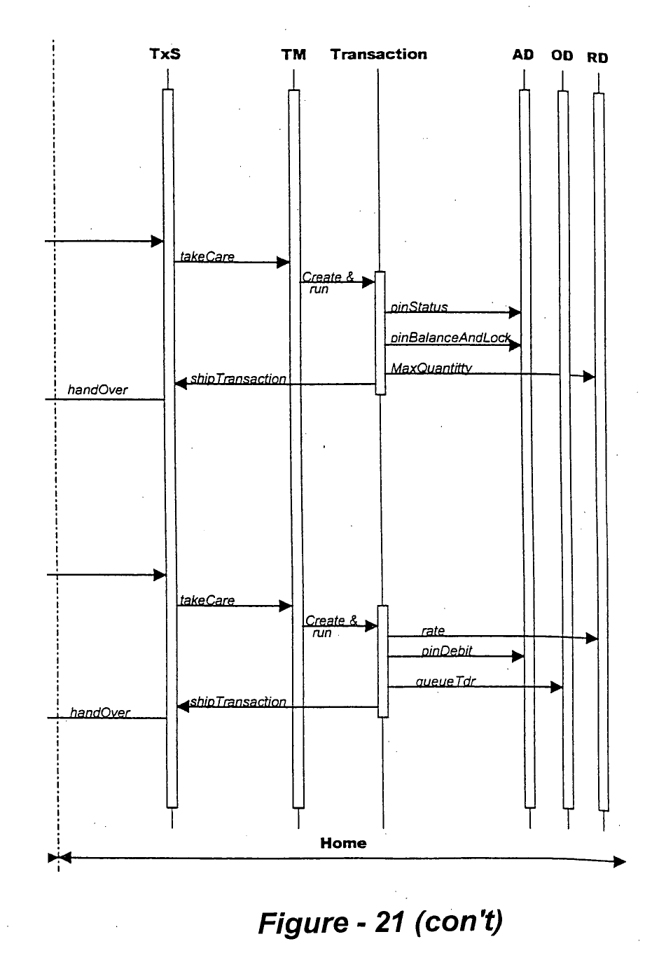

FIG. 21 depicts object interaction for the transaction shipments that occur in the typical roaming situation. In this example, the transaction is initiated on the foreign TxS and first ships on to home TxS to execute the following transactions steps:

AD.pinStatus,

AD.pinBalanceAndLock, and

RD.maxQuantity.

It then ships back to the Foreign TxS for proceeding with the service device. It ships again to Home TxS to execute:

RD.rate,

AD.pinDebit, and

OD.queueTdr.

1. A method of performing a prepaid electronic-commerce transaction over a computer network, comprising the steps of:
receiving user identification and account balance information at a centralized transaction server interfaced to the network;
receiving a request for goods or services at the centralized transaction server from the user through an input device;
creating a transaction instance at the centralized transaction server in response to the user request;
retrieving account information at the centralized transaction server relating to the user, the account information including the user's remaining balance;
determining whether or not the transaction can take place as a function of the user's remaining balance;
proceeding with the transaction and servicing the request if the user's account is sufficiently funded;
calculating the purchase price of the goods or services based on information contained in the user request using a rating device; and
updating user's remaining balance at the centralized transaction server.

2. The method of claim 1, wherein the transaction occurs over the internet.

3. The method of claim 1, wherein the transaction occurs over an intranet.

4. The method of claim 1, wherein the transaction occurs over an extranet.

5. The method of claim 1, wherein the request is received through a point-of-sale (POS) terminal.

6. The method of claim 1, further including the step of:
denying further service requests when a predetermined spending threshold is reached.

7. The method of claim 1, wherein the input is received through a web page.

8. The method of claim 1, wherein the step of calculating the purchase price of the requested goods or services occurs substantially in real time.

9. The method of claim 8, wherein the purchase price is a dollar or less.

10. The method of claim 1, wherein:
the steps associated with receiving the request from the user and servicing the request are performed at different locations.

11. The method of claim 10, wherein one of the different locations is associated with requesting a payment, and wherein that location passes accounting and rating information to the first location.

12. The method of claim 1, further including the step of providing the user with an estimated purchase price over the network before a purchase is made.

13. The method of claim 1, further including the step of providing the user with a history of payments over the network.

14. The method of claim 1, further including the step of allowing the user to move funds from a bank or credit card account to the centralized transaction server to increase the remaining balance.

15. The method of claim 1, wherein the input device forms part of a personal digital assistant.

16. The method of claim 1, wherein the step of calculating the cost of the requested goods or services is based upon the amount of time spent in using the goods or services.

17. The method of claim 16, wherein the goods or services involve downloading reading material.

18. The method of claim 16, wherein the goods or services involve a form of entertainment.

19. A method of performing a prepaid electronic-commerce transaction for a user having an account, comprising the steps of:
receiving a request from a user over a computer network, thereby creating a transaction instance;
calculating the cost of the transaction based on information contained in the user request; and
debiting the user's account in accordance with the cost upon termination of the transaction.

20. The method of claim 19, further including the steps of:
retrieving account information at least including the user's remaining balance;
determining whether or not the transaction can take place as a function of the user's remaining balance;
proceeding with the transaction if the user's account is sufficiently funded; and
updating the user's remaining balance upon termination of the transaction.

21. The method of claim 19, wherein the computer network is the internet, an intranet, or extranet.
